(19) United States
(12) Patent Application Publication
(10) Pub. No.: US 2025/0029111 A1
(43) Pub. Date: Jan. 23, 2025

(54) METHODS AND SYSTEMS FOR FIRST CONTACT RESOLUTION

(71) Applicant: Exelon Corporation, Chicago, IL (US)

(72) Inventors: Benjamin Carls, Chicago, IL (US); Swapnesh Nair, Chicago, IL (US)

(21) Appl. No.: 18/354,978

(22) Filed: Jul. 19, 2023

(51) Int. Cl. G06Q 30/015; G06N 5/022; G06Q 10/0639

(52) U.S. Cl. CPC G06Q 30/015; G06N 5/022; G06Q 10/06393

(57) ABSTRACT

Methods, systems, and apparatuses for predicting an estimate of a number of contacts a customer may perform before resolving one or more issues associated with the customer or a suggestion for resolving one or more issues associated with the customer. Contact data associated with customer data and first contact resolution (FCR) metric data may be used to train a predictive model. The predictive model may be trained to output a prediction indicative of one or more of a resolution of one or more issues associated with a customer within one or more contacts, and a suggestion for resolving one or more issues associated with the customer.

### BACKGROUND

Conventionally, a contact center may be staffed with agents who may serve as an interface between an organization, or entity, and external customers. For example, support agents at contact centers may assist customers in resolving their problems, or issues, such as problems with products or services provided by the organization. Organizations continue to increase the number of channels for customers to increasingly interact and get their issues resolves. For example, interactions between contact center agents and external customers may be conducted via channels such as speech voice (e.g., telephone calls or voice over IP or VOIP calls), video (e.g., video conferencing), text (e.g., emails and text chat), mobile applications a web site or web portal, or through other media. Organizations often use a first contact resolution metric in order to track customer issues getting resolved in first contact. Conventional methods of determining first contact resolution (FCR) metrics generally track customer journeys within a single channel of communication. However, the nature of customer interactions varies across different channel. Unfortunately, the conventional methods of determining FCR metrics often lack insights into cross-channel journeys for customers. For example, utility entities currently use a FCR metric which only captures how many interactions a customer has via the interactive voice response (IVR) or customer service representative (CSR) channels. Moreover, the application of machine learning models to the use of an incomplete FCR metric for predicting whether a given contact is resolved decreases the accuracy of that prediction.

Furthermore, one of the biggest issues facing the use of machine learning is the lack of availability of large, annotated datasets. The annotation of data is not only expensive and time consuming but also highly dependent on the availability of expert observers. The limited amount of training data can inhibit the performance of supervised machine learning algorithms which often need very large quantities of data on which to train to avoid overfitting. So far, much effort has been directed at extracting as much information as possible from what data is available. One area in particular that suffers from lack of large, annotated datasets is the analysis of customer data associated with cross-channel journeys for customers and the relationships between the customers and FCR metrics associated with one or more entities. The ability to analyze data associated with cross-channel journeys for customers and the relationships between customers and the FCR metric is critical for planning and allocating resources to accommodate large volumes of customers contacting the call centers and resolve the customers' problems. However, in many instances, insufficient data are available to train machine learning algorithms to accurately predict an estimate of cross-channel journeys for customers and the relationships between the customer data and FCR metric data.

### SUMMARY

It is to be understood that both the following general description and the following detailed description are exemplary and explanatory only and are not restrictive.

In an embodiment, disclosed are methods comprising determining, by a computing device, contact data associated with customer data and first contact resolution (FCR) metric data, wherein the contact data comprises one or more groups of contact characteristics, wherein each group of contact characteristics of the one or more groups of contact characteristics is labeled according to a predefined feature of a plurality of predefined features, determining, based on the contact data, a plurality of features for a predictive model, training, based on a first portion of the contact data, the predictive model according to the plurality of features, testing, based on a second portion of the contact data, the predictive model, and outputting, based on the testing, the predictive model.

In an embodiment, disclosed are methods comprising determining, based on the customer data and the FCR metric data, one or more contact data sets that comprise one or more groups of one or more customer data sets characteristics and one or more FCR metric data sets, and generating, based on the one or more contact data sets, the contact data.

In an embodiment, disclosed are methods comprising determining baseline feature levels for each group of contact characteristics of the one or more groups of contact characteristics, labeling the baseline feature levels for each group of contact characteristics of the one or more groups of contact characteristics as at least one predefined feature of the plurality of predefined features, and generating, based on the labeled baseline feature levels, the contact data.

In an embodiment, disclosed are methods comprising of receiving, at a computing device, contact data associated with customer data and first contact resolution (FCR) metric data, providing, to a predictive model, the contact data, and determining, based on the predictive model, a prediction indicative of one or more of a resolution of one or more issues associated with a customer within one or more contacts, and a suggestion for resolving one or more issues associated with the customer.

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of the present description serve to explain the principles of the methods and systems described herein:

FIG. 1 shows an example system;

FIG. 2 shows a flowchart of an example method;

FIG. 3 shows an example machine learning system;

FIG. 4 shows a flowchart of an example machine learning method;

FIG. 5 shows an example computer system for implementing the machine learning system;

FIG. 6 shows a flowchart of an example method; and

FIG. 7 shows a flowchart of an example method.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. Similarly, when values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, the methods and systems may take the form of a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

Generally, as discussed herein, the terms “customer data” refer to data, or information, associated with the interaction between one or more customers and an entity. For example, the information may include one or more of information associated with the content of one or more types of contacts between the one or more customers and the entity, information associated with one or more channels used to initiate the one or more contacts between the one or more customers and the entity, or time information associated with each contact of one or more contacts. The one or more types of contacts may include billing and payments types of contacts, credit and collections types of contacts, or start/stop/move (SSM) types of contacts. As an example, the content of the one or more types of contacts may include words spoken between the customer and the entity, topics discussed between the customer and the entity, and the like. The one or more channels may include a customer service representative (CSR) channel, an interactive voice response (IVR) channel, a website channel, or a user device application channel. The time information may comprise one or more of a time of day, a day of a week, a time range of the day, a range of days of the week, a month, or a range of days of the month.

Generally, as discussed herein, the terms “FCR metric data,” or “First Contact Resolution metric data,” may refer to data associated with a percentage of customer contacts between one or more customers and an entity that are resolved within a first contact. In other words, the FCR metric data may include a percentage of the number of customer contacts wherein one or more issues of the customer are resolved within the first contact between the customer and the entity. As an example, the FCR metric data may include FCR metrics associated with one or more entities, one or more business functions with each entity, etc.

Generally, as discussed herein, the terms “contact data” refer to data that includes both the customer data and the FCR metric data. For example, the contact data may comprise one or more subsets of data that may include at least one subset of data associated with the customer data and at least one subset of data associated with the FCR metric data.

Generally, as discussed herein, the term “entity” refers to a business, an organization, and the like that may utilize a call center for resolving customer issues.

Generally, as discussed herein, the term “customer” refers to a person, or individual, that may initiate a contact with the entity via one or more channels in order to resolve one or more issues.

Methods and systems are described for generating a machine learning classifier to output a prediction indicative of a resolution of one or more issues associated with a customer within one or more contacts, and a suggestion for resolving one or more issues associated with the customer. For example, a customer may contact an entity via one or more channels (e.g., a customer service representative (CSR) channel, an interactive voice response (IVR) channel, a website channel, a user device application channel, etc.) to resolve one or more issues (e.g., problems with products and/or services). Machine learning (ML) is a subfield of computer science that gives computers the ability to learn without being explicitly programmed. Machine learning platforms include, but are not limited to, naïve Bayes classifiers, support vector machines, decision trees, neural networks, and the like.

In an example, contact data may be received. The contact data may comprise customer data and first contact resolution (FCR) metric data. The customer data may comprise data associated with a plurality of customers. The data may comprise one or more of information associated with content of one or more types of contacts associated with each customer of the plurality of customers, information associated with one or more contacts via one or more channels associated with each customer, or time information associated with each contact of one or more contacts. The one or more types of contacts may comprise one or more of billing and payments, credit and collections, and start/stop/move (SSM). The one or more channels may comprise one or more of a customer service representative (CSR) channel, an interactive voice response (IVR) channel, a website channel, and a user device application channel. The time information may comprise one or more of a time of day, a day of a week, a time range of the day, a range of days of the week, a month, or a range of days of the month. The FCR metric data may be associated with a plurality of entities. The FCR metric data may comprise a plurality of percentages of customer contacts resolved on a first contact. The machine learning classifier, or predictive model, may be trained using the contact data associated with the customer data and the FCR metric data. The predictive model may output a prediction indicative of a resolution of one or more issues associated with a customer within one or more contacts, and a suggestion for resolving one or more issues associated with the customer.

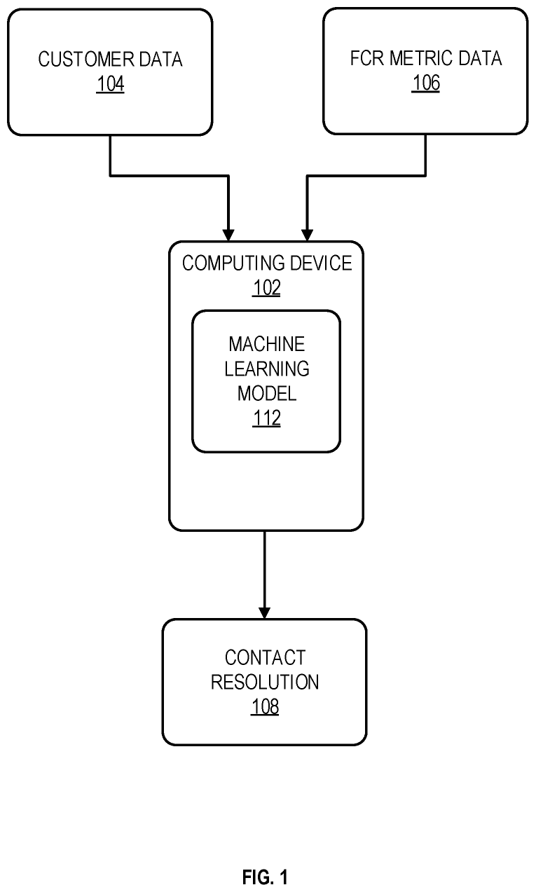

FIG. 1 shows a system 100 that may be configured for using machine learning and/or artificial intelligence to determine (e.g., predict) one or more of a resolution of one or more issues associated with a customer within one or more contacts and a suggestion for resolving one or more issues associated with the customer based on FCR metric data and customer data associated with one or more types of contacts via one or more channels of an entity.

As shown in FIG. 1, the system 100 may comprise a computing device 102 (e.g., a user device, a server, a cloud device, a central computing device, etc.). The computing device 102 may be associated with an entity (e.g., service/utility provider, a utility management system, business, organization, etc.). The computing device 102 may be configured at (or disposed at) a central location (e.g., a headend, a processing facility, a service/utility provider, entity organization, etc.) and may be configured to receive the contact data from a variety of sources. As an example, the computing device 102 may receive customer data 104 from one or more sources such as one or more databases associated with one or more entities. For example, the customer data 104 may comprise data associated with a plurality of customers. The data may comprise one or more of information associated with content of one or more types of contacts associated with each customer of the plurality of customers, information associated with one or more contacts via one or more channels associated with each customer, or time information associated with each contact of one or more contacts. The one or more types of contacts may comprise one or more of billing and payments, credit and collections, and start/stop/move (SSM). The one or more channels may comprise one or more of a customer service representative (CSR) channel, an interactive voice response (IVR) channel, a website channel, and a user device application channel. The time information may comprise one or more of a time of day, a day of a week, a time range of the day, a range of days of the week, a month, or a range of days of the month.

As an example, the computing device 102 may receive first contact resolution (FCR) metric data 106 from one or more sources such as one or more databases associated with one or more entities. As an example, the FCR metric may comprise a measure of how effectively an entity's contact center, and other channels of customer interactions, for example, resolve customer issues. The FCR metric may dependent on one or more factors (e.g., complexity and types of transactions handled). For example, data for determining the FCR metric may be received (e.g., obtained) from various resources or databases of an entity. For example, the data may include a plurality of source system tables and a plurality of customer interactions indicative of customer journeys across website sessions, IVR menu selections, CSR transactions, etc. For example, the different categories of contacts (e.g., calls) may comprise one or more of multiple-channel contacts, contact reasons, two-step transactions, two-factor call authorization, and first contact resolved. The multi-channel category of contacts may be associated with customers contacting one channel to solve an issue and making one or more subsequent contacts via other channels to resolve their issue. The contact reason category of contacts may be associated with customers contacting a contact center within seven days for multiple different reasons. The two-step transactions category of contacts may be associated with customers contacting a contact center to resolve an issue that requires a two-step call process for resolving. For example, functionalities such as “stop service” may be followed by an immediate subsequent contact to “start service.” The two-factor call authorization category of contacts may be associated with contacts that involve two touch-points for verification purposes, such as, for example, for calls that may require verification of credentials. The first contact resolved type of contact may be associated with contacts that were released, or resolved, in the first contact.

As an example, the FCR metric may be calculated by dividing a total number of customer contacts resolved on a first attempt by a total number of contacts in a time period (e.g., day, week, month, quarter, year, etc.) and then multiplying the result by 100 to determine a percentage. The numerator may comprise a unique customer identifier (e.g., customer/category combination) associated with the total number of contacts resolved on a first contact. For example, the contact may be counted towards the FCR metric if no additional customer contacts for a type of contact within a time period (e.g., days, weeks, etc.) of the contact. The contact may be counted against the FCR metric if a customer makes a subsequent within the time period (e.g., days, weeks, etc.) from the initial contact and is only accounted for once regardless of the number of additional contacts. The denominator may comprise a total of unique contacts during a time period (e.g., day, week, month, quarter, year, etc.). For example, the contact may be counted for the FCR metric if the customer completes a type of contact (e.g., billing and payments) without following up another contact associated with the same type of contact (e.g., billing and payments) again within a time period (e.g., days, weeks, etc.). The contact may be counted against the FCR metric if the customer completes the type of contact (e.g., billing and payments) and then follows up with a contact associated with the same type of contact (e.g., billing and payments) the next day even if the subsequent contact involves a different channel of communication (e.g., CSR for the first contact vs. IVR for the second contact). As an example, the contact may still be counted if the customer follows up the next day with a contact associated with another type of contact (e.g., credit and collections).

As an example, the customer data 104 and the FCR metric data 106 may be received as subsets of contact data. For example, the computing device 102 may receive the contact data from one or more sources such as one or more databases associated with one or more entities. The contact data may comprise data associated with one or more customers and one or more entities. In an example, the contact data may comprise data indicative of associations between one or more groups of customer data and one or more groups of FCR metric data. For example, an FCR metric may be correlated with a certain type of contact (e.g., billing and payments, credit and collections, and SSM), a channel (e.g., CSR, IVR, etc.) associated with the contact, or time information (e.g., time of day, day of a week, time range of the day, etc.) associated with the contact. The computing device 102 may be configured to parse the contact data to determine the subsets of the contact data pertaining to the customer data 104 and the FCR metric data 106.

The customer data 104 and the FCR metric data 106 may be used to form one or more contact datasets. For example, the one or more contact datasets may comprise one or more groups of one or more customer data characteristics associated with the customer data 104 and one or more groups of FCR metric data characteristics associated with the FCR metric data 106. The one or more datasets may comprise labeled data and/or target features (e.g., ordinal features, nominal features, etc.) based on associations between one or more portions of the customer data (e.g., one or more groups of one or more customer data characteristics) and one or more portions of the FCR metric data (e.g., one or more groups of FCR metric data characteristics). As an example, the one or more groups of one or more customer data characteristics may include one or more groups of one or more types of contacts associated with each customer of the plurality of customers, one or more channels associated with one or more contacts from each customer, or time information associated with each contact. As an example, the one or more groups of FCR metric data characteristics may include one or more groups of FCR metric ranges or FCR metrics associated with one or more customer categories (e.g., customer locations, customer demographics, customer age ranges, customer backgrounds, etc.).

The one or more datasets may be provided as inputs to a machine learning model 112. The machine learning model 112 may be trained based on the inputs in order to predict one or more of a resolution of one or more issues associated with a customer within one or more contacts and a suggestion for resolving one or more issues associated with the customer based on the datasets of the contact data. As an example, generative AI may be implemented to increase the value of the FCR metric. For example, a large language model (LLM) may be implemented to generate a notice (e.g. notification) to a representative of the entity assisting the customer during a contact (e.g., call with a contact center of the entity) that the contact may be difficult to resolve. The LLM may be configured to supply customized proactive contacts via one or more channels (e.g., email, SMS, etc.) when a contact is deemed unsuccessful.

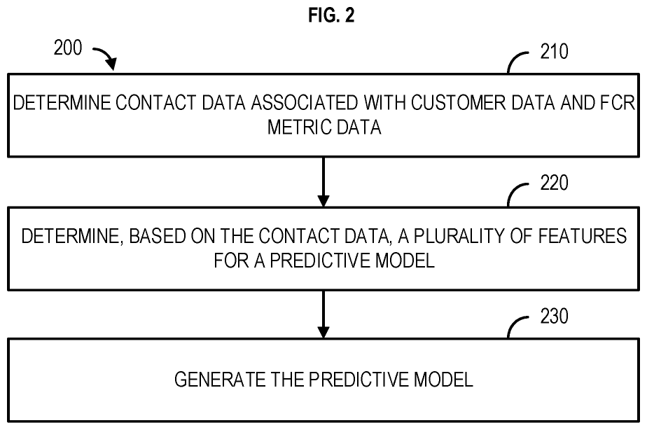

FIG. 2 shows a flowchart of an example method 200 for generating a predictive model comprising receiving contact data associated with customer data and first contact resolution (FCR) metric data at 210, determining, based on the contact data, a plurality of features for a predictive model at 220, and generating, based on the plurality of features, a predictive model at 230.

Determining the contact data associated with the customer data and the FCR metric data at 210 may comprise downloading/obtaining/receiving customer data sets and FCR metric data sets from various sources, including recent publications and/or publically available databases. For example, the customer data sets and the FCR metric data sets may be obtained from one or more sources such as one or more databases associated with one or more entities (e.g., service/utility provider, a utility management system, business, organization, etc.). In an example, the contact data may comprise one or more subsets of data wherein at least one subset of the contact data may comprise the customer data and at least another subset of the contact data may comprise the FCR metric data. The contact data may be downloaded/obtained/received from various sources, including recent publications and/or publically available databases. The customer data may comprise data associated with a plurality of customers. The data may comprise one or more of information associated with content of one or more types of contacts associated with each customer of the plurality of customers, information associated with one or more contacts via one or more channels associated with each customer, or time information associated with each contact of one or more contacts. The one or more types of contacts may comprise one or more of billing and payments, credit and collections, and start/stop/move (SSM). The one or more channels may comprise one or more of a customer service representative (CSR) channel, an interactive voice response (IVR) channel, a website channel, and/or a user device application channel. The time information may comprise one or more of a time of day, a day of a week, a time range of the day, a range of days of the week, a month, or a range of days of the month. The FCR metric data may be associated with a plurality of entities. The FCR metric data may comprise a plurality of percentages of customer contacts resolved on a first contact.

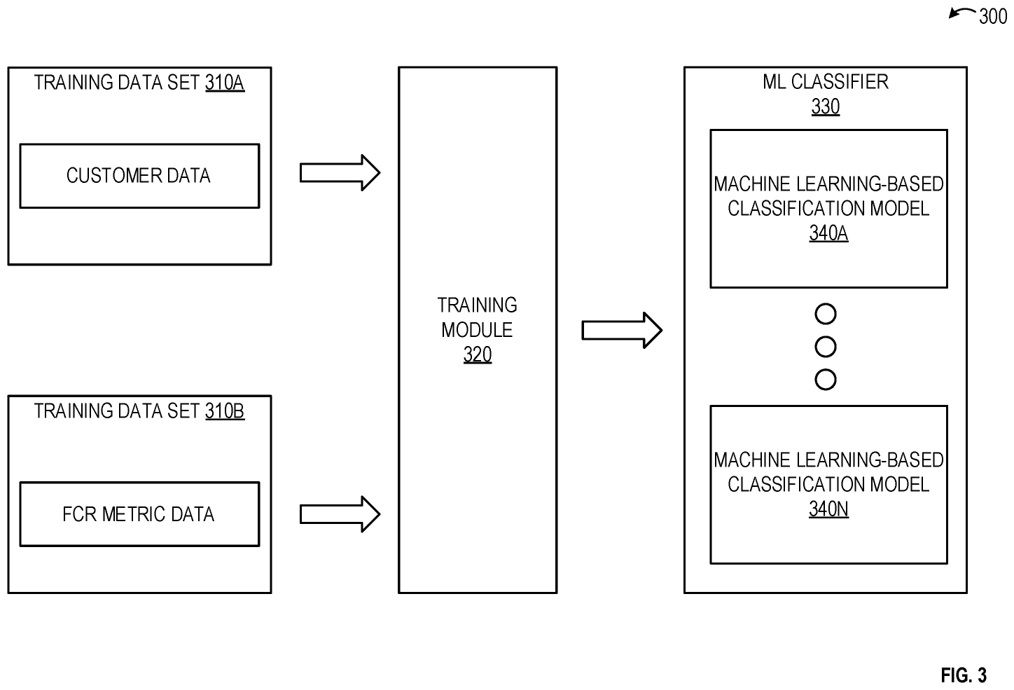

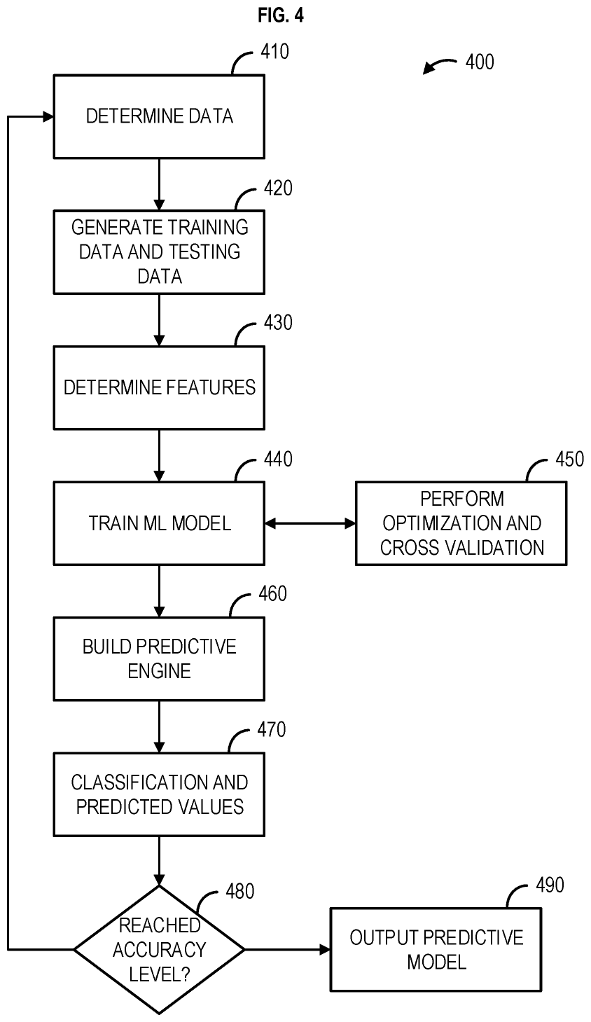

Determining, based on the contact data, a plurality of features for a predictive model at 220 and generating, based on the plurality of features, a predictive model at 230 are described with regard to FIG. 3 and FIG. 4.

A predictive model (e.g., a machine learning classifier) may be generated to provide a prediction indicative one or more of a resolution of one or more issues associated with a customer within one or more contacts, and a suggestion for resolving one or more issues associated with the customer. The prediction may be used to enable one or more entities to efficiently plan and allocate resources to accommodate large volumes of customers contacting the entities and resolve the customers' problems. The predictive model may be trained according to the contact data (e.g. one or more contact data sets and/or baseline feature levels) associated with customer data and FCR metric data. The baseline feature levels may relate to one or more groups of contact characteristics, wherein each group of contact characteristics may be associated with at least one association of a plurality of associations between one or more portions of the customer data (e.g., one or more groups of one or more customer data characteristics) and one or more portions of the FCR metric data (e.g., one or more groups of FCR metric data characteristics). As an example, the baseline feature levels, or group of contact characteristics, may be associated with a correlation between an FCR metric and a certain type of contact (e.g., billing and payments, credit and collections, and SSM), a channel (e.g., CSR, IVR, etc.) associated with the contact, or time information (e.g., time of day, day of a week, time range of the day, etc.) associated with a contact. In an example, one or more features of the predictive model may be extracted from one or more of the contact data sets and/or the baseline feature levels.

FIG. 3 shows a system 300 that may be configured to use machine learning techniques to train, based on an analysis of one or more training data sets 310A-310B by a training module 320, at least one machine learning-based classifier 330 that may be configured to classify an expected number of contacts associated with resolving one or more issues of one or more customers and/or an expected suggestion for resolving one or more issues of the one or more customers. As an example, the training data sets 310A-310B may comprise one or more contact data sets. For example, the one or more contact data sets may comprise the one or more groups of customer data characteristics and the one or more groups of first contact resolution (FRC) metric data characteristics. As an example, the one or more groups of one or more customer data characteristics may include one or more groups of one or more types of contacts associated with each customer of the plurality of customers, one or more channels associated with one or more contacts from each customer, or time information associated with each contact. As an example, the one or more groups of FCR metric data characteristics may include one or more groups of FCR metric ranges or FCR metrics associated with one or more customer categories (e.g., customer locations, customer demographics, customer age ranges, customer backgrounds, etc.). As an example, the training data set 310A (e.g., the customer data) may comprise one or more customer data sets and the training data set 310B (e.g., the FCR metric data) may comprise one or more FCR metric data sets. As an example, the training data sets 310A-310B may comprise labeled baseline feature levels. The labels may comprise a plurality of predefined features associated with the one or more portions of customer data and/or the one or more portions of FCR metric data.

The training module 320 may train the machine learning-based classifier 330 by extracting a feature set from the contact data (e.g., one or more contact data sets and/or baseline feature levels) in the training data set 310 according to one or more feature selection techniques.

In an example, the training module 320 may extract a feature set from the training data set 310A and the training data set 310B in a variety of ways. The training module 320 may perform feature extraction multiple times, each time using a different feature-extraction technique. As an example, the feature sets generated using the different techniques may each be used to generate different machine learning-based classification models 340. As an example, the feature set with the highest quality metrics may be selected for use in training. The training module 320 may use the feature set(s) to build one or more machine learning-based classification models 340A-340N that are configured to indicate whether or not new data is associated with a resolution of one or more issues associated with a customer within one or more contacts and/or a suggestion for resolving one or more issues associated with the customer.

In an example, the training data sets 310A-310B may be analyzed to determine one or more groups of contact characteristics that have at least one feature that may be used to predict the resolution of one or more issues associated with a customer within one or more contacts and/or the suggestion for resolving one or more issues associated with the customer. As an example, the at least one feature may comprise one or more characteristics associated with one or more customer data characteristics and one or more FCR metric data characteristics. The customer data may comprise data associated with a plurality of customers. The data may comprise one or more of information associated with content of one or more types of contacts associated with each customer of the plurality of customers, information associated with one or more contacts via one or more channels associated with each customer, or time information associated with each contact of one or more contacts. The one or more types of contacts may comprise one or more of billing and payments, credit and collections, and/or start/stop/move (SSM). The one or more channels may comprise one or more of a customer service representative (CSR) channel, an interactive voice response (IVR) channel, a website channel, and/or a user device application channel. The time information may comprise one or more of a time of day, a day of a week, a time range of the day, a range of days of the week, a month, or a range of days of the month. The FCR metric data may be associated with a plurality of entities. The FCR metric data may comprise a plurality of percentages of customer contacts resolved on a first contact. As an example, the one or more groups of one or more customer data characteristics may include one or more groups of one or more types of contacts associated with each customer of the plurality of customers, one or more channels associated with one or more contacts from each customer, or time information associated with each contact. As an example, the one or more groups of FCR metric data characteristics may include one or more groups of FCR metric ranges or FCR metrics associated with one or more customer categories (e.g., customer locations, customer demographics, customer age ranges, customer backgrounds, etc.). The one or more groups of contact characteristics may be considered as features (or variables) in the machine learning context. The term “feature,” as used herein, may refer to any characteristic of a group of contact data that may be used to determine whether the group of contact characteristics fall within one or more specific categories.

In an example, a feature selection technique may comprise one or more feature selection rules. The one or more feature selection rules may comprise a contact characteristic occurrence rule. In an example, the one or more feature selection rules may comprise a customer data characteristic and an FCR metric data characteristic occurrence rule. The contact characteristic occurrence rule may comprise determining which contact characteristics, or group of contact characteristics, in the training data sets 310A-310B occur over a threshold number of times and identifying those contact characteristics that satisfy the threshold as candidate features. For example, any contact characteristic, or group of contact characteristics, that appear greater than or equal to 50 times in the training data sets 310A-310B may be considered as candidate features. Any contact characteristic, or group of contact characteristics, appearing less than 50 times may be excluded from consideration as a feature.

In an example, the one or more feature selection rules may comprise a significance rule. The significance rule may comprise determining, from the baseline feature level data in the training data sets 310A-310B, contact characteristic data, wherein the contact characteristic data includes one or more customer data characteristics and one or more FRC metric data characteristics. As the baseline feature level in the training data sets 310A-310B are labeled according to one or more contact characteristics, the labels may be used to determine the contact characteristic data.

In an example, a single feature selection rule may be applied in order to select features or multiple feature selection rules may be applied in order to select the features. For example, the feature selection rules may be applied in a cascading fashion, with the feature selection rules being applied in a specific order and applied to the results of the previous rule. For example, the contact characteristic occurrence rule may be applied to the training data sets 310A-310B to generate a first list of features. The significance rule may be applied to features in the first list of features to determine which features of the first list satisfy the significance rule in the training data sets 310A-310B and to generate a final list of candidate features.

The final list of candidate features may be analyzed according to additional feature selection techniques to determine one or more candidate feature signatures (e.g., groups of contact characteristics that may be used to predict a resolution of one or more issues associated with a customer within one or more contacts and/or a suggestion for resolving one or more issues associated with the customer). Any suitable computational technique may be used to identify the candidate feature signatures using any feature selection technique such as filter, wrapper, and/or embedded methods. In an example, one or more candidate feature signatures may be selected according to a filter method. Filter methods include, for example, Pearson's correlation, linear discriminant analysis, analysis of variance (ANOVA), chi-square, combinations thereof, and the like. The selection of features according to filter methods are independent of any machine learning algorithms. Instead, features may be selected on the basis of scores in various statistical tests for their correlation with the outcome variable (e.g., a resolution of one or more issues associated with a customer within one or more contacts and/or a suggestion for resolving one or more issues associated with the customer).

In an example, one or more candidate feature signatures may be selected according to a wrapper method. A wrapper method may be configured to use a subset of features and train a machine learning model using the subset of features. Based on the inferences that are drawn from a previous model, features may be added and/or deleted from the subset. Wrapper methods include, for example, forward feature selection, backward feature elimination, recursive feature elimination, combinations thereof, and the like. As an example, forward feature selection may be used to identify one or more candidate feature signatures. Forward feature selection is an iterative method that begins with no feature in the machine learning model. In each iteration, the feature which best improves the model is added until an addition of a new variable does not improve the performance of the machine learning model. As an example, backward elimination may be used to identify one or more candidate feature signatures. Backward elimination is an iterative method that begins with all features in the machine learning model. In each iteration, the least significant feature is removed until no improvement is observed on removal of features. As an example, recursive feature elimination may be used to identify one or more candidate feature signatures. Recursive feature elimination is a greedy optimization algorithm which aims to find the best performing feature subset. Recursive feature elimination repeatedly creates models and keeps aside the best or the worst performing feature at each iteration. Recursive feature elimination constructs the next model with the features remaining until all the features are exhausted. Recursive feature elimination then ranks the features based on the order of their elimination.

In an example, one or more candidate feature signatures may be selected according to an embedded method. Embedded methods combine the qualities of filter and wrapper methods. Embedded methods include, for example, Least Absolute Shrinkage and Selection Operator (LASSO) and ridge regression which implement penalization functions to reduce overfitting. For example, LASSO regression performs L1 regularization which adds a penalty equivalent to the absolute value of the magnitude of coefficients and ridge regression performs L2 regularization which adds a penalty equivalent to the square of the magnitude of coefficients.

After the training module 320 has generated a feature set(s), the training module 320 may generate a machine learning-based classification model 340 based on the feature set(s). The machine learning-based classification model 340, may refer to a complex mathematical model for data classification that is generated using machine-learning techniques. In an example, this machine learning-based classifier may include a map of support vectors that represent boundary features. For example, boundary features may be selected from, and/or represent the highest-ranked features in, a feature set.

In an example, the training module 320 may use the feature sets extracted from the training data sets 310A-310B to build a machine learning-based classification model 340A-340N for each classification category (e.g., a resolution of one or more issues associated with a customer within one or more contacts prediction and/or a suggestion for resolving one or more predicted issues associated with the customer). In an example, a plurality of machine learning-based classification models 340A-340N may be used for each classification category (e.g., a resolution of one or more issues associated with a customer within one or more contacts prediction and/or a suggestion for resolving one or more predicted issues associated with the customer). For example, an automatic recognition model/algorithm may be used to determine the final machine learning model. For example, the resolution of one or more issues associated with a customer within one or more contacts prediction and/or the suggestion for resolving one or more predicted issues associated with the customer may be determined for each machine learning-based classification model 340A-340N. The final machine learning model may be determined based on the machine learning model with the most accurate prediction of the previous resolution of one or more issues associated with a customer within one or more contacts prediction and/or the suggestion for resolving one or more predicted issues associated with the customer. In an example, the machine learning-based classification models 340A-340N may be combined into a single machine learning-based classification model 340. Similarly, the machine learning-based classifier 330 may represent a single classifier containing a single or a plurality of machine learning-based classification models 340 and/or multiple classifiers containing a single or a plurality of machine learning-based classification models 340.

The extracted features (e.g., one or more candidate features and/or candidate feature signatures derived from the final list of candidate features) may be combined in a classification model trained using a machine learning approach such as discriminant analysis; decision tree; extreme gradient boosting (XGBoost); ensemble regression (ENS); a nearest neighbor (NN) algorithm (e.g., k-NN models, replicator NN models, etc.); statistical algorithm (e.g., Bayesian networks, etc.); clustering algorithm (e.g., k-means, mean-shift, etc.); neural networks (e.g., reservoir networks, artificial neural networks, etc.); support vector machines (SVMs); logistic regression algorithms; linear regression algorithms; Markov models or chains; principal component analysis (PCA) (e.g., for linear models); multi-layer perceptron (MLP) ANNs (e.g., for non-linear models); replicating reservoir networks (e.g., for non-linear models, typically for time series); random forest classification; a combination thereof and/or the like. The resulting machine learning-based classifier 330 may comprise a decision rule or a mapping that uses the expression levels of the features in the candidate feature signature to predict a resolution of one or more issues associated with a customer within one or more contacts and/or a suggestion for resolving one or more issues associated with the customer.

The candidate feature signature and the machine learning-based classifier 330 may be used to provide a prediction indicative of a resolution of one or more issues associated with a customer within one or more contacts and/or a suggestion for resolving one or more predicted issues associated with the customer in the testing data sets 310A-310B. In an example, the result for each test includes a confidence level that corresponds to a likelihood or a probability that the corresponding test predicted a resolution of one or more issues associated with a customer within one or more contacts and/or a suggestion for resolving one or more predicted issues associated with the customer. The confidence level may be a value between zero and one that represents a likelihood that the corresponding test is associated with a resolution of one or more issues associated with a customer within one or more contacts and/or a suggestion for resolving one or more predicted issues associated with the customer. In an example, when there are two or more statuses (e.g., two or more expected resolutions of one or more issues associated with a customer within one or more contacts and/or suggestions for resolving one or more predicted issues associated with the customer), the confidence level may correspond to a value p, which refers to a likelihood that a particular test is associated with a first status. In this case, the value 1-p may refer to a likelihood that the particular test is associated with a second status. In general, multiple confidence levels may be provided for each test and for each candidate feature signature when there are more than two statuses. A top performing candidate feature signature may be determined by comparing the result obtained for each test with known expected numbers of contacts for resolving one or more issues associated with a customer results and/or the known suggestions for an expected one or more issues associated with the customer results for each test. In general, the top performing candidate feature signature will have results that closely match the known expected numbers of contacts for resolving one or more issues associated with a customer results and/or the known suggestions for an expected one or more issues associated with the customer results.

The top performing candidate feature signature may be used to predict the expected numbers of contacts for resolving one or more issues associated with a customer results and/or the suggestions for an expected one or more issues associated with the customer results. For example, contact data and/or baseline feature data may be determined/received. The contact data and/or the baseline feature data may be provided to the machine learning-based classifier 330 which may, based on the top performing candidate feature signature, predict/determine a resolution of one or more issues associated with a customer within one or more contacts or a suggestion for resolving one and/or more issues associated with the customer. As an example, based on the predicted/determined number of contacts for resolving one or more issues associated with a customer and/or the expected one or more issues associated with the customer, an entity may provide one or more suggestions for resolving the predicted one or more issues associated with the customer. In an example, generative AI may be implemented to increase the value of the FCR metric. For example, a large language model (LLM) may be implemented to generate a notice (e.g. notification) to a representative of the entity assisting the customer during a contact (e.g., call with a contact center of the entity) that the contact may be difficult to resolve. The LLM may be configured to supply customized proactive contacts via one or more channels (e.g., email, SMS, etc.) when a contact is deemed unsuccessful.

FIG. 4 shows a flowchart of an example training method 400 for generating the machine learning-based classifier 330 using the training module 320. The training module 320 may be implement using supervised, unsupervised, and/or semi-supervised (e.g., reinforcement based) machine learning-based classification models 340. The method 400 shown in FIG. 4 is an example of a supervised learning method. Although, variations of this example of training method are discussed below, other training methods may be analogously implemented to train unsupervised and/or semi-supervised machine learning models.

The training method 400 may determine (e.g., access, receive, retrieve, etc.) contact data associated with customer data and first contact resolution (FCR) metric data at 410. The contact data may contain one or more datasets, wherein each dataset may be associated with a particular study. Each study may involve historical data from one or more entities, although it is contemplated that some study overlap may occur. In an example, each dataset may include a labeled list of predetermined features. As an example, the labels may be associated with one or more contact characteristics. For example, the one or more contact characteristics may be associated with a correlation between an FCR metric and a certain type of contact (e.g., billing and payments, credit and collections, and SSM), a channel (e.g., CSR, IVR, etc.) associated with the contact, or time information (e.g., time of day, day of a week, time range of the day, etc.) associated with a contact. As an example, the labels may be associated with one or more customer data characteristics and one or more FCR metric data characteristics. The customer data may comprise data associated with a plurality of customers. The data (or customer data characteristics) may comprise one or more of information associated with content of one or more types of contacts associated with each customer of the plurality of customers information associated with one or more contacts via one or more channels associated with each customer, or time information associated with each contact of one or more contacts. The one or more types of contacts may comprise one or more of billing and payments, credit and collections, and/or start/stop/move (SSM). The one or more channels may comprise one or more of a customer service representative (CSR) channel, an interactive voice response (IVR) channel, a website channel, and/or a user device application channel. The time information may comprise one or more of a time of day, a day of a week, a time range of the day, a range of days of the week, a month, or a range of days of the month. The FCR metric data may be associated with a plurality of entities. The FCR metric data may comprise a plurality of percentages of customer contacts resolved on a first contact. In an example, the FCR characteristics may comprise one or more groups of FCR metric ranges or FCR metrics associated with one or more customer categories (e.g., customer locations, customer demographics, customer age ranges, customer backgrounds, etc.).

The training method 400 may generate, at 420, a training data set and a testing data set. The training data set and the testing data set may be generated by randomly assigning labeled feature data of individual features from the contact data to either the training data set or the testing data set. In an example, the assignment of the labeled feature data of individual features may not be completely random. In an example, only the labeled feature data for a specific study may be used to generate the training data set and the testing data set. In an example, a majority of the labeled feature data for the specific study may be used to generate the training data set. For example, 75% of the labeled feature data for the specific study may be used to generate the training data set and 25% may be used to generate the testing data set. In an example, only the labeled feature data for the specific study may be used to generate the training data set and the testing data set.

The training method 400 may determine (e.g., extract, select, etc.), at 430, one or more features that can be used by, for example, a classifier to differentiate among different classifications (e.g., a resolution of one or more issues associated with a customer within one or more contacts and/or a suggestion for resolving one or more issues associated with the customer). The one or more features may comprise a group of contact data sets such as a group of contact characteristics or a group of customer data characteristics and FCR metric data characteristics. In an example, the training method 400 may determine a set of features from the contact data. In an example, a set of features may be determined from contact data from a study different than the study associated with the labeled feature data of the training data set and the testing data set. In other words, the contact data from the different study (e.g., curated contact data sets) may be used for feature determination, rather than for training a machine learning model. In an example, the training data set may be used in conjunction with the contact data from the different study to determine the one or more features. The contact data from the different study may be used to determine an initial set of features, which may be further reduced using the training data set.

The training method 400 may train one or more machine learning models using the one or more features at 440. As an example, the machine learning models may be trained using supervised learning. As an example, other machine learning techniques may be employed, including unsupervised learning and semi-supervised. The machine learning models trained at 440 may be selected based on different criteria depending on the problem to be solved and/or data available in the training data set. For example, machine learning classifiers can suffer from different degrees of bias. Accordingly, more than one machine learning model may be trained at 440, optimized, improved, and cross-validated at 450. For example, an automatic recognition model/algorithm may be used to determine the final machine learning model based on a plurality of machine learning models. For example, a number of contacts for resolving one or more issues associated with a customer prediction and/or a prediction of one or more issues associated with the customer may be determined based on each machine learning-based classification model. The final machine learning model may be determined based on the model with the most accurate prediction of the previous number of contacts for resolving one or more issues associated with a customer and/or suggestions for resolving one or more issues associated with the customer.

The training method 400 may select one or more machine learning models to build a predictive model at 460 (e.g., a machine learning classifier). The predictive model may be evaluated using the testing data set. The predictive model may analyze the testing data set and generate classification values and/or predicted values at 470. Classification and/or prediction values may be evaluated at 480 to determine whether such values have achieved a desired level of performance. Performance of the predictive model may be evaluated in a number of ways based on a number of true positive, false positive, true negative, and/or false negative classifications of the plurality of data points indicated by the predictive model. For example, the false positives of the predictive model may refer to a number of times the predictive model incorrectly classified a number of contacts for resolving one or more issues associated with a customer and/or a suggestion for resolving one or more issues associated with the customer based on the contact data. Conversely, the false negatives of the predictive model may refer to a number of times the machine learning model determined that a number of contacts for resolving one or more issues associated with a customer and/or a suggestion for resolving one or more issues associated with the customer or a range of a number of contacts for resolving one or more issues associated with a customer and/or a range of suggestions for resolving one or more issues associated with the customer were not associated with the contact data when, in fact, the contact data was associated with the number of contacts for resolving one or more issues associated with a customer and/or the suggestions for resolving the one or more issues associated with the customer or the range of the numbers of contacts for resolving one or more issues associated with a customer and/or the range of the suggestions for resolving the one or more issues associated with the customer. True negatives and true positives may refer to a number of times the predictive model correctly classified a number of contacts for resolving one or more issues associated with a customer and/or a suggestion for resolving one or more issues associated with the customer based on the contact data. Related to these measurements are the concepts of recall and precision. Generally, recall refers to a ratio of true positives to a sum of true positives and false negatives, which quantifies a sensitivity of the predictive model. Similarly, precision refers to a ratio of true positives and a sum of true and false positives.

When a desired level of performance is reached, the training phase ends and the predictive model may be output at 490; when the desired level of performance is not reached, however, then a subsequent iteration of the training method 400 may be performed starting at 410 with variations such as, for example, considering a larger collection of contact data.

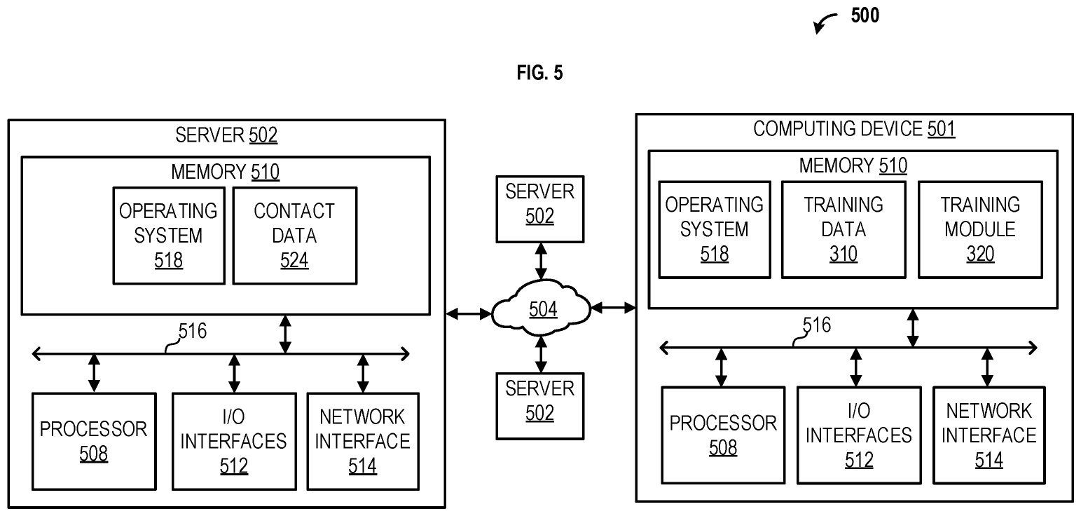

FIG. 5 shows an example computer system 500 for determining a resolution of one or more issues associated with a customer within one or more contacts and/or a suggestion for resolving one or more issues associated with the customer based on contact data associated with customer data and FCR metric data. For example, system 500 may comprise a computing device 501 and a server 502 connected via a network 504. In an example, some or all steps of any described method may be performed on a computing device as described herein. The computing device 501 may comprise one or more computers configured to store one or more of the training module 320, training data 310 (e.g., contact data and/or labeled baseline feature data), and the like. The server 502 may comprise one or more computers configured to store the contact data 524. One or more servers 502 may communicate with the computing device 501 via the network 504.

The computing device 501 and the server 502 may comprise a digital computer, wherein the digital computer may comprise a processor 508, memory system 510, one or more input/output (I/O) interfaces 512, and one or more network interfaces 514. In an example, the computing device 501 may comprise one or more of a smartphone, a mobile device, a smartwatch, a tablet computer, a laptop computer, or a desktop computer. The processor 508, the memory system 510, the one or more input/output (I/O) interfaces 512, and the one or more network interfaces 514 may be in communication with each other via a local interface 516. The local interface 516 may comprise one or more buses or other wired or wireless connections. The local interface 516 may comprise additional elements, which are omitted for simplicity, such as controllers, buffers (caches), drivers, repeaters, and receivers, to enable communications. The local interface 516 may further include address, control, and/or data connections to enable appropriate communications among the processor 508, the memory system 510, the one or more input/output (I/O) interfaces 512, and the one or more network interfaces 514.

The processor 508 may be a hardware device for executing software, particularly that may be stored in memory system 510. The processor 508 may be any custom made or commercially available processor, a central processing unit (CPU), an auxiliary processor among several processors associated with the computing device 501 and the server 502, a semiconductor-based microprocessor (in the form of a microchip or chip set), or generally any device for executing software instructions. When the computing device 501 and/or the server 502 is in operation, the processor 508 may be configured to execute software stored within the memory system 510, to communicate data to and from the memory system 510, and to generally control operations of the computing device 501 and the server 502 pursuant to the software.

The one or more I/O interfaces 512 may comprise one or more interfaces for receiving user input from, and/or for providing system output to, one or more devices or components. User input may be provided via, for example, a keyboard and/or a mouse. System output may be provided via a display device and a printer (not shown). I/O interfaces 512 may include, for example, a serial port, a parallel port, a Small Computer System Interface (SCSI), an infrared (IR) interface, a radio frequency (RF) interface, and/or a universal serial bus (USB) interface.

The one or more network interfaces 514 may be used to transmit and receive data from the computing device 501 and/or the server 502 on the network 504. The network interface 514 may include, for example, a 10BaseT Ethernet Adaptor, a 100BaseT Ethernet Adaptor, a LAN PHY Ethernet Adaptor, a Token Ring Adaptor, a wireless network adapter (e.g., WiFi, cellular, satellite), or any other suitable network interface device. The one or more network interfaces 514 may include address, control, and/or data connections to enable appropriate communications on the network 504.

The memory system 510 may include any one or combination of volatile memory elements (e.g., random access memory (RAM, such as DRAM, SRAM, SDRAM, etc.)) and nonvolatile memory elements (e.g., ROM, hard drive, tape, CDROM, DVDROM, etc.). Moreover, the memory system 510 may incorporate electronic, magnetic, optical, and/or other types of storage media. Note that the memory system 510 may have a distributed architecture, wherein various components are situated remote from one another, but may be accessed by the processor 508.

The software in the memory system 510 may include one or more software programs, each of which comprises an ordered listing of executable instructions for implementing logical functions. The software in the memory system 510 of the computing device 501 may comprise the training module 320 (or subcomponents thereof), the training data 310, and a suitable operating system (O/S) 518. The software in the memory system 510 of the server 502 may comprise, the contact data 524 and a suitable operating system (O/S) 518. The operating system 518 may control the execution of other computer programs and provide scheduling, input-output control, file and data management, memory management, and communication control, and related services.

As shown in FIG. 5, application programs and other executable program components, such as the operating system 518, are depicted as discrete blocks. However, it is recognized that such programs and components may reside at various times in different storage components of the computing device 501 and/or the server 502. As an example, the training module 320 may be stored on or transmitted across some form of computer readable media. Any of the disclosed methods may be performed by computer readable instructions embodied on computer readable media. Computer readable media may be any available media that can be accessed by a computer. For example, computer readable media may comprise “computer storage media” and “communications media.” “Computer storage media” may comprise volatile and non-volatile, removable and non-removable media implemented in any method or technology for storage of information such as computer readable instructions, data structures, program modules, or other data. In an example, computer storage media may comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

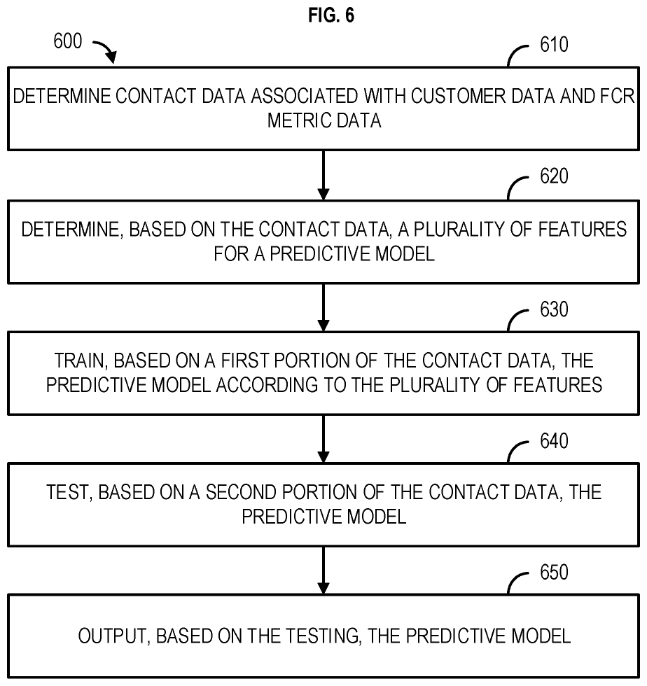

FIG. 6 shows a flowchart of an example method 600. The method 600 may be implemented in whole, or in part, by computing device 501, server 502, or any other suitable device. For example, method 600 may be implemented in whole, or in part, by the training model 320. At step 610, contact data associated with customer data and first contact resolution (FCR) metric data may be determined. For example, the contact data may comprise one or more groups of contact characteristics. The one or more groups of contact characteristics may be labeled according to a predefined feature of a plurality of predefined features. As an example, the one or more groups of contact characteristics may be associated with a correlation between an FCR metric and a certain type of contact (e.g., billing and payments, credit and collections, and SSM), a channel (e.g., CSR, IVR, etc.) associated with the contact, or time information (e.g., time of day, day of a week, time range of the day, etc.) associated with the contact. The customer data may comprise data associated with a plurality of customers. The data may comprise one or more of information associated with content of one or more types of contacts associated with each customer of the plurality of customers, information associated with one or more contacts via one or more channels associated with each customer, or time information associated with each contact of one or more contacts. The one or more types of contacts may comprise one or more of billing and payments, credit and collections, and/or start/stop/move (SSM). The one or more channels may comprise one or more of a customer service representative (CSR) channel, an interactive voice response (IVR) channel, a website channel, and/or a user device application channel. The time information comprises one or more of a time of day, a day of a week, a time range of the day, a range of days of the week, a month, or a range of days of the month. The FCR metric data may be associated with a plurality of entities. The FCR metric data may comprise a plurality of percentages of customer contacts resolved on a first contact. The plurality of predefined features may comprise a plurality of associations between one or more portions of the customer data and one or more portions of the FCR metric data.

In an example, the contact data may be received from a public data source. As an example, determining the contact data may comprise determining, based on the customer data and the FCR metric data, one or more contact data sets that comprise one or more groups of one or more customer data characteristics and one or more groups of FCR metric data characteristics, and generating, based on the one or more contact data sets, the contact data. As an example, determining the contact data may comprise determining baseline feature levels for each group of contact characteristics of the one or more groups of contact characteristics, labeling the baseline feature levels for each group of contact characteristics of the one or more groups of contact characteristics as at least one predefined feature of the plurality of predefined features, and generating, based on the labeled baseline feature levels, the contact data. As an example, the one or more groups of one or more customer data characteristics may include one or more groups of one or more types of contacts associated with each customer of the plurality of customers, one or more channels associated with one or more contacts from each customer, or time information associated with each contact. As an example, the one or more groups of FCR metric data characteristics may include one or more groups of FCR metric ranges or FCR metrics associated with one or more customer categories (e.g., customer locations, customer demographics, customer age ranges, customer backgrounds, etc.).

At step 620, a plurality of features for a predictive model may be determined based on the contact data. For example, determining the plurality of features for the predictive model may comprise determining, from the contact data, features present in two or more contact data sets of a plurality of contact data sets as a first set of candidate contact characteristics, determining, from the contact data, features of the first set of candidate contact characteristics that satisfy a first threshold score as a second set of candidate contact characteristics, and determining, from the contact data, features of the second set of candidate contact characteristics that satisfy a second threshold score as a third set of candidate contact characteristics, wherein the plurality of features comprises the third set of candidate contact characteristics. In an example, determining the plurality of features for the predictive model may comprise determining, for the third set of candidate contact characteristics, a feature score for each contact characteristic of a plurality of contact characteristics associated with the third set of candidate contact characteristics, determining, based on the feature score, a fourth set of candidate contact characteristics, wherein the plurality of features comprises the fourth set of candidate contact characteristics.

At step 630, the predictive model may be trained, based on a first portion of the contact data, according to the plurality of features. For example, training, based on the first portion of the contact data, the predictive model according to the plurality of features may comprise, or result in, determining a feature signature indicative of at least one predefined feature of the plurality of predefined features. At step 640, the predictive model may be tested based on a second portion of the contact data.

At step 650, the predictive model may be output based on the testing. The predictive model may be configured to output a prediction indicative of a resolution of one or more issues associated with a customer within one or more contacts or a suggestion for resolving one or more issues associated with the customer. The prediction may be used to enable one or more entities to efficiently plan and allocate resources to accommodate large volumes of customers contacting the entities and resolve the customers' problems. In an example, generative AI may be implemented to increase the value of the FCR metric. For example, a large language model (LLM) may be implemented to generate a notice (e.g. notification) to a representative of the entity assisting the customer during a contact (e.g., call with a contact center of the entity) that the contact may be difficult to resolve. The LLM may be configured to supply customized proactive contacts via one or more channels (e.g., email, SMS, etc.) when a contact is deemed unsuccessful.

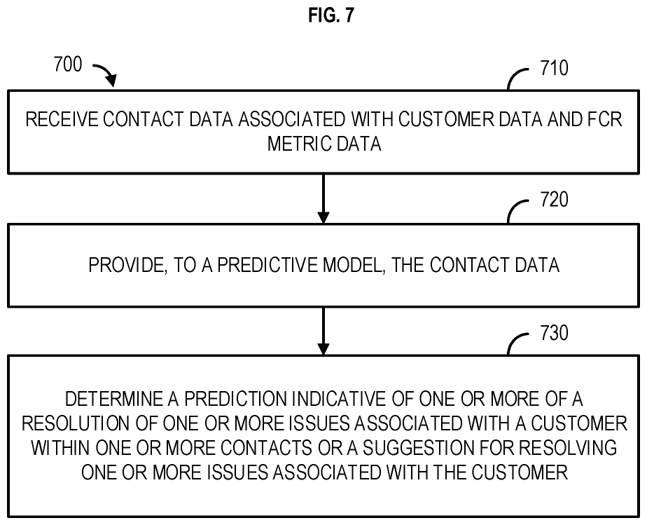

FIG. 7 shows a flowchart of an example method 700. The method 700 may be implemented in whole, or in part, by computing device 501, server 502, or any other suitable device. For example, method 700 may be implemented in whole, or in part, by the training model 320. At step 710, contact data associated with customer data and first contact resolution (FCR) metric data may be received. The customer data may comprise data associated with a customer. The data may comprise one or more of information associated with content of one or more types of contacts associated with the customer, information associated with one or more contacts via one or more channels associated with the customer, or time information associated with each contact of one or more contacts. The one or more types of contacts may comprise one or more of billing and payments, credit and collections, and/or start/stop/move (SSM). The one or more channels may comprise one or more of a customer service representative (CSR) channel, an interactive voice response (IVR) channel, a website channel, and/or a user device application channel. The time information may comprise one or more of a time of day, a day of a week, a time range of the day, a range of days of the week, a month, or a range of days of the month. The FCR metric data may be associated with an entity. The FCR metric data may comprise a percentage of customer contacts resolved on a first contact.

At step 720, the contact data may be provided to a predictive model. At step 730, a prediction indicative of a resolution of one or more issues associated with the customer within one or more contacts or a suggestion for resolving one or more issues associated with the customer may be determined based on the predictive model. In an example, the prediction may be used to enable the entity to efficiently plan and allocate resources to accommodate large volumes of customers contacting the entities and resolve the customers' problems. In an example, generative AI may be implemented to increase the value of the FCR metric. For example, a large language model (LLM) may be implemented to generate a notice (e.g. notification) to a representative of the entity assisting the customer during a contact (e.g., call with a contact center of the entity) that the contact may be difficult to resolve. The LLM may be configured to supply customized proactive contacts via one or more channels (e.g., email, SMS, etc.) when a contact is deemed unsuccessful.

Method 700 may further comprise training the predictive model. For example, determining, by a computing device, contact data associated with customer data and FCR metric data, wherein the contact data comprises one or more groups of contact characteristics, wherein each group of contact characteristics of the one or more groups of contact characteristics is labeled according to a predefined feature of a plurality of predefined features, determining, based on the contact data, a plurality of features for the predictive model, training, based on a first portion of the contact data, the predictive model according to the plurality of features, testing, based on a second portion of the contact data, the predictive model, and outputting, based on the testing, the predictive model. As an example, the one or more groups of contact characteristics may be associated with a correlation between an FCR metric and a certain type of contact (e.g., billing and payments, credit and collections, and SSM), a channel (e.g., CSR, IVR, etc.) associated with the contact, or time information (e.g., time of day, day of a week, time range of the day, etc.) associated with the contact.

As an example, the plurality of predefined features may comprise a plurality of associations between one or more portions of the customer data and one or more portions of the FCR metric data. In an example, the contact data may be received from a public data source. As an example, determining the contact data may comprise determining, based on the customer data and the FCR metric data, one or more contact data sets that comprise one or more groups of one or more customer data characteristics and one or more groups of FCR metric data characteristics, and generating, based on the one or more contact data sets, the contact data. As an example, determining the contact data may comprise determining baseline feature levels for each group of contact characteristics of the one or more groups of contact characteristics, labeling the baseline feature levels for each group of contact characteristics of the one or more groups of contact characteristics as at least one predefined feature of the plurality of predefined features, and generating, based on the labeled baseline feature levels, the contact data. As an example, the one or more groups of one or more customer data characteristics may include one or more groups of one or more types of contacts associated with each customer of the plurality of customers, one or more channels associated with one or more contacts from each customer, or time information associated with each contact. As an example, the one or more groups of FCR metric data characteristics may include one or more groups of FCR metric ranges or FCR metrics associated with one or more customer categories (e.g., customer locations, customer demographics, customer age ranges, customer backgrounds, etc.).

Determining the plurality of features for the predictive model based on the contact data may comprise determining, from the contact data, features present in two or more contact data sets of a plurality of contact data sets as a first set of candidate contact characteristics, determining, from the contact data, features of the first set of candidate contact characteristics that satisfy a first threshold score as a second set of candidate contact characteristics, and determining, from the contact data, features of the second set of candidate contact characteristics that satisfy a second threshold score as a third set of candidate contact characteristics, wherein the plurality of features comprises the third set of candidate contact characteristics. In an example, determining the plurality of features for the predictive model based on the contact data may comprise determining, for the third set of candidate contact characteristics, a feature score for each contact characteristic of a plurality of contact characteristics associated with the third set of candidate contact characteristics, and determining, based on the feature score, a fourth set of candidate contact characteristics, wherein the plurality of features comprises the fourth set of candidate contact characteristics.

Training, based on the first portion of the contact data, the predictive model according to the plurality of features may comprise, or result in, determining a signature indicative of at least one predefined feature of the plurality of predefined features.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

1. A method comprising:
determining, by a computing device, contact data associated with customer data and first contact resolution (FCR) metric data, wherein the contact data comprises one or more groups of contact characteristics, wherein each group of contact characteristics of the one or more groups of contact characteristics is labeled according to a predefined feature of a plurality of predefined features;
determining, based on the contact data, a plurality of features for a predictive model;
training, based on a first portion of the contact data, the predictive model according to the plurality of features;
testing, based on a second portion of the contact data, the predictive model; and
outputting, based on the testing, the predictive model.

2. The method of claim 1, wherein the customer data comprises data associated with a plurality of customers, wherein the data comprises one or more of information associated with content of one or more types of contacts associated with each customer of the plurality of customers, information associated with one or more contacts via one or more channels associated with each customer, or time information associated with each contact of one or more contacts.

3. The method of claim 2, wherein the one or more types of contacts comprises one or more of billing and payments, credit and collections, or start/stop/move (SSM), wherein the one or more channels comprise one or more of a customer service representative (CSR) channel, an interactive voice response (IVR) channel, a website channel, or a user device application channel, and wherein the time information comprises one or more of a time of day, a day of a week, a time range of the day, or a range of days.

4. The method of claim 1, wherein the FCR metric data is associated with a plurality of entities, and wherein the FCR metric data comprises a plurality of percentages of customer contacts resolved on a first contact.

5. The method of claim 1, wherein determining the contact data comprises:
determining, based on the customer data and the FCR metric data, one or more contact data sets that comprise one or more groups of one or more customer data sets characteristics and one or more FCR metric data sets; and
generating, based on the one or more contact data sets, the contact data.

6. The method of claim 1, wherein determining the contact data comprises:
determining baseline feature levels for each group of contact characteristics of the one or more groups of contact characteristics;
labeling the baseline feature levels for each group of contact characteristics of the one or more groups of contact characteristics as at least one predefined feature of the plurality of predefined features; and
generating, based on the labeled baseline feature levels, the contact data.

7. The method of claim 1, wherein determining, based on the contact data, the plurality of features for the predictive model comprises:
determining, from the contact data, features present in two or more contact data sets of a plurality of contact data sets as a first set of candidate contact characteristics;
determining, from the contact data, features of the first set of candidate contact characteristics that satisfy a first threshold score as a second set of candidate contact characteristics; and
determining, from the contact data, features of the second set of candidate contact characteristics that satisfy a second threshold score as a third set of candidate contact characteristics,
wherein the plurality of features comprises the third set of candidate contact characteristics.

8. The method of claim 1, wherein determining, based on the contact data, the plurality of features for the predictive model comprises:
determining, for the third set of candidate contact characteristics, a feature score for each contact characteristic of a plurality of contact characteristics associated with the third set of candidate contact characteristics; and
determining, based on the feature score, a fourth set of candidate contact characteristics,
wherein the plurality of features comprises the fourth set of candidate contact characteristics.

9. The method of claim 1, wherein training, based on the first portion of the contact data, the predictive model according to the plurality of features results in determining a feature signature indicative of at least one predefined feature of the plurality of predefined features.

10. The method of claim 1, wherein the predictive model is configured to output a prediction indicative of one or more of: a resolution of one or more issues associated with a customer within one or more contacts or a suggestion for resolving one or more issues associated with the customer.

11. A method comprising:
receiving, at a computing device, contact data associated with customer data and first contact resolution (FCR) metric data;
providing, to a predictive model, the contact data; and
determining, based on the predictive model, a prediction indicative of one or more of a resolution of one or more issues associated with a customer within one or more contacts or a suggestion for resolving one or more issues associated with the customer.

12. The method of claim 11, wherein the customer data comprises data associated with the customer communicating via a channel of an entity, wherein the data comprises one or more of information associated with content of at least one type of contact associated with the customer, information associated with the channel of the entity, or time information associated with each contact of one or more contacts.

13. The method of claim 12, wherein the at least one type of contact comprises one or more of billing and payments, credit and collections, or start/stop/move (SSM), wherein the channel comprises one or more of a customer service representative (CSR) channel, an interactive voice response (IVR) channel, a website channel, or a user device application channel, and wherein the time information comprises one or more of a time of day, a day of a week, a time range of the day, or a range of days.

14. The method of claim 11, wherein the FCR metric data is associated with an entity, wherein the FCR metric data comprises a percentage of customer contacts resolved on a first contact.

15. The method of claim 11, further comprising training the predictive model.

16. The method of claim 15, wherein training the predictive model comprises:
determining contact data associated with the customer data and the FCR metric data, wherein the contact data comprises one or more groups of contact characteristics, wherein each group of contact characteristics of the one or more groups of contact characteristics is labeled according to a predefined feature of a plurality of predefined features;
determining, based on the contact data, a plurality of features for the predictive model;
training, based on a first portion of the contact data, the predictive model according to the plurality of features;
testing, based on a second portion of the contact data, the predictive model; and
outputting, based on the testing, the predictive model.

17. The method of claim 16, wherein determining the contact data comprises:
determining, based on the customer data, one or more contact data sets that comprise one or more groups of one or more customer data characteristics and one or more FCR metric data characteristics; and
generating, based on the one or more contact data sets, the contact data.

18. The method of claim 16, wherein determining the contact data comprises:
determining baseline feature levels for each group of contact characteristics of the one or more groups of contact characteristics;
labeling the baseline feature levels for each group of contact characteristics of the one or more groups of contact characteristics as at least one predefined feature of the plurality of predefined features; and
generating, based on the labeled baseline feature levels, the contact data.

19. The method of claim 16, wherein determining, based on the contact data, the plurality of features for the predictive model comprises:
determining, from the contact data, features present in two or more contact data sets of a plurality of contact data sets as a first set of candidate contact characteristics;
determining, from the contact data, features of the first set of candidate contact characteristics that satisfy a first threshold score as a second set of candidate contact characteristics; and
determining, from the contact data, features of the second set of candidate contact characteristics that satisfy a second threshold score as a third set of candidate contact characteristics,
wherein the plurality of features comprises the third set of candidate contact characteristics.

20. The method of claim 16, wherein determining, based on the contact data, the plurality of features for the predictive model comprises:
determining, for the third set of candidate contact characteristics, a feature score for each contact characteristic of a plurality of contact characteristics associated with the third set of candidate contact characteristics; and
determining, based on the feature score, a fourth set of candidate contact characteristics,
wherein the plurality of features comprises the fourth set of candidate contact characteristics.
